(19) United States
(12) Patent Application Publication
(10) Pub. No.: US 2014/0304960 A1
(43) Pub. Date: Oct. 16, 2014

(54) METHOD OF INSTALLING MISTING FIRE SUPPRESSION SPRINKLERS INTO A BUILDING PREVIOUSLY CONTAINING AT LEAST ONE OTHER TYPE OF SPRINKLER

(71) Applicant: UTC FIRE & SECURITY CORPORATION, Farmington, CT (US)

(72) Inventors: Guido Poncia, Glastonbury, CT (US); Timothy Galante, West Hartford, CT (US)

(21) Appl. No.: 14/351,208

(22) PCT Filed: Oct. 14, 2011
(86) PCT No.: PCT/US2011/056276

§ 371 Date: Apr. 11, 2014

(51) Int. Cl. A62C 35/68

(52) U.S. Cl. CPC A62C 35/68
USPC 29/401.1

(57) ABSTRACT

An exemplary method of installing misting fire suppression sprinklers into a building previously containing at least one other type of sprinkler includes installing at least one misting fire suppression sprinkler where it can introduce a fire suppression mist into a selected portion of the building. Fluid communication is established between the misting fire suppression sprinkler and a liquid supply conduit previously within the building that has been configured to supply fire suppression liquid to the other type of sprinkler. A gas supply conduit is installed within the building in fluid communication with the missing fire suppression sprinkler. The gas from the gas supply conduit and liquid from the liquid supply conduit allow the misting fire suppression sprinkler to selectively produce a fire suppression mist within the selected portion of the building.

### BACKGROUND

There are a variety of fire suppression sprinkler systems. Different systems provide different types of fire suppression discharge. Some systems are considered deluge systems as they release a large amount of water into an area where fire suppression is needed. Other systems include sprinklers that spray water into an area for suppressing or extinguishing a fire, for example. While such systems have proven useful, there are situations in which updating or replacing at least a portion of such a sprinkler system is desirable. For example, a misting system may be desired where a traditional sprinkler systems exists. Conventional thinking has required completely replacing an existing sprinkler system with a more up-to-date system. That approach can be expensive and in some cases is not feasible. Further challenges are introduced when a new or different type of sprinkler is desired in a building that already has a more traditional sprinkler arrangement.

### SUMMARY

An exemplary method of installing misting fire suppression sprinklers into a building previously containing at least one other type of sprinkler includes installing at least one misting fire suppression sprinkler where it can introduce a fire suppression mist into a selected portion of the building. Fluid communication is established between the misting fire suppression sprinkler and a liquid supply conduit previously within the building that has been configured to supply fire suppression liquid to the other type of sprinkler. A gas supply conduit is installed within the building in fluid communication with the misting fire suppression sprinkler. The gas from the gas supply conduit and liquid from the liquid supply conduit allow the misting fire suppression sprinkler to selectively produce a fire suppression mist within the selected portion of the building.

The various features and advantages of disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates a sprinkler system installed according to an embodiment of this invention.

FIG. 2 schematically illustrates another example arrangement of a sprinkler system including sprinklers installed according to an embodiment of this invention.

### DETAILED DESCRIPTION

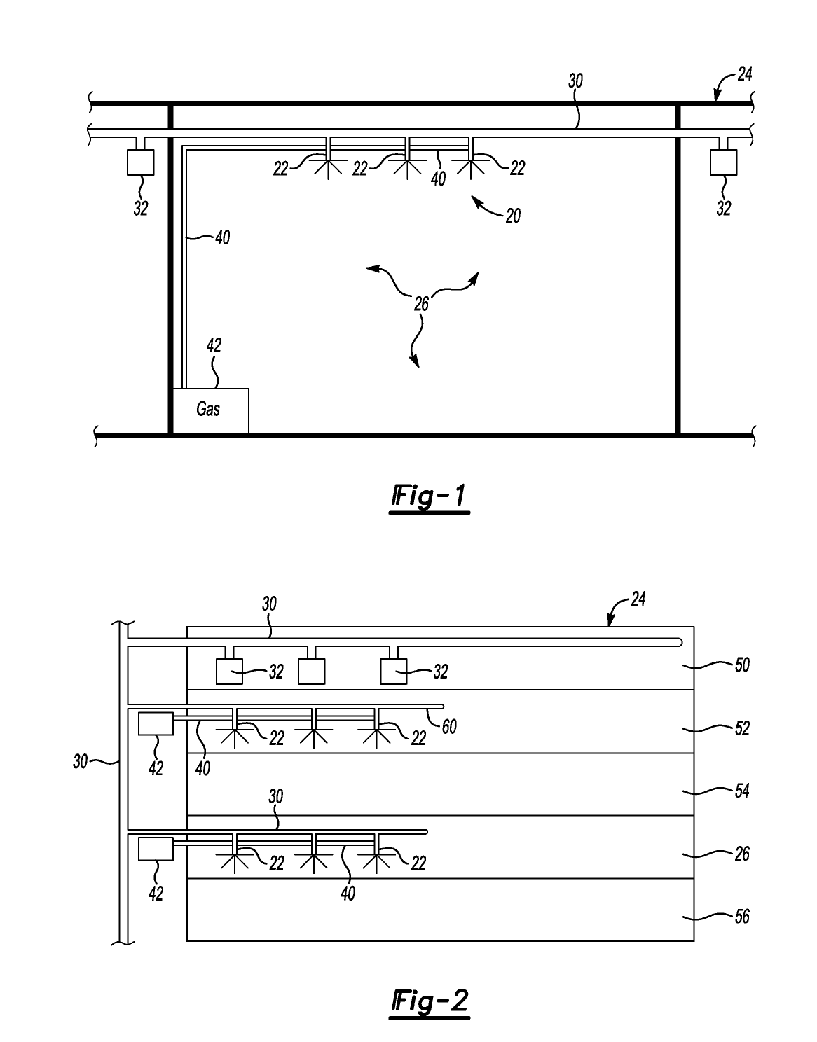

FIG. 1 schematically shows a sprinkler system 20 including a plurality of misting fire suppression sprinklers 22 within a building 24. The misting fire suppression sprinklers 22 have been installed within the building 24 where they provide fire suppression protection at least within a selected portion 26 of the building 24.

The misting fire suppression sprinklers 22 can be referred to as twin fluid or dual fluid sprinklers because they utilize two fluids (e.g., water and air) to achieve a desired fire suppression discharge. The illustrated example sprinklers 22 provide a water mist discharge. In one example the sprinklers 22 comprise effervescent sprinklers. Such sprinklers use effervescent atomization to provide a fire suppression mist discharge. One feature of twin fluid sprinklers is that they are capable of operating using relatively low liquid and gas pressures. This provides savings in terms of materials because there is no need for complicated or expensive pumps, for example.

The misting fire suppression sprinklers 22 have been installed within the building 24 as an update or retrofit to an existing sprinkler system already within the building 24. The illustrated example includes a pre-existing liquid supply conduit 30 that was already in the building 24 for supplying fire suppression liquid to sprinklers 32 that were previously in the building 24 (i.e., before the misting fire suppression sprinklers 22 were installed). In this example, the sprinklers 32 are a different type of sprinkler compared to the misting fire suppression sprinklers 22. The sprinklers 32 are conventional sprinklers. In one example, the sprinklers 32 are configured to spray a relatively larger amount of water (compared to the amount discharged by the misting sprinklers 22) into areas of the building 24 that are protected by those sprinklers.

One example installation technique includes installing the misting fire suppression sprinklers 22 within the building 24 to provide protection within the portion 26 of the building 24. Liquid supply for the sprinklers 22 is obtained from the liquid conduit 30. An example technique includes establishing fluid communication between the liquid supply conduit 30 and the misting fire suppression sprinklers 22. In the example of FIG. 1, the sprinklers 22 are coupled with the liquid supply conduit 30 using a connector configured for establishing a connection with the liquid supply conduit 30 and one of the sprinklers 22.

A gas supply conduit 40 is installed in the building 24 for delivering gas from a gas source 42 to the misting fire suppression sprinkles 22. The gas source 42 may comprise pressurized gas containers or a compressor, for example. In the illustrated example, the gas supply conduit 40 is coupled with the sprinklers 22, themselves. In another example, an intermediate connection is established between the gas supply conduit 40 and the sprinklers 22 so that the gas is delivered to an appropriate portion of the sprinklers for realizing the desired misting fire suppression discharge. One example includes providing the gas source 42 within the building 24 or nearby the building and outside of it.

In one example, the liquid used for fire suppression purposes comprises water. The gas supplied to the sprinklers 22 in one example comprises air. Other inert gases are used in some examples.

In some examples, water pressure as provided by a municipal water supply is sufficient and slightly higher gas pressure is sufficient to realize a misting fire suppression discharge. For example, typical water pressures are in the range of 40 psi to 80 psi (2800 gram-force/cm² to 5625 gram-force/cm²). The gas pressure may be in a range from less than 1 psi (70 gram-force/cm²) to about 5 psi (350 gram-force/cm²) above the water (or other liquid) supply pressure. In one example, the gas pressure is between 40 psi (2800 gram-force/cm²) and 85 psi (6000 gram-force/cm²). These low pressures provide economic advantages because no expensive pumps are required and there is no requirement for components rated for high pressure.

The installation technique of this example allows for including dual fluid misting fire suppression sprinklers 22 within at least a portion of a building that already has fire suppression sprinklers installed even though those sprinkles are of a different type than the misting fire suppression sprinklers 22.

FIG. 2 schematically shows a building 24 including different areas or portions such as suites, rooms, floors, etc. For example, the portion 26 from FIG. 1 is illustrated after the misting fire suppression sprinklers 22 and the associated gas supply conduit 40 have been installed. Another area 50 of the building 24 is protected by pre-existing sprinklers 32 that are not misting sprinklers. Another area 52 of the building 24 now includes misting fire suppression sprinklers 22. Installing those sprinklers includes providing a new liquid supply conduit 60 that is coupled with the liquid supply conduit 30 for distributing the liquid to the misting fire suppression sprinklers 22 within the area 52. In this example, the area 52 previously was not provided with any fire suppression sprinkler system. This example illustrates how selected portions of a building may be provided with new misting fire suppression sprinklers 22 even though another type of sprinkler system already existed within the building. Two other portions 54 and 56 of the building 24 do not have any fire suppression sprinkler system installed.

The example of FIG. 2 shows how an existing fire suppression sprinkler system can be updated and different portions of a building may be treated differently. For example, the area 50 maintains the existing sprinklers 32, the area 52 includes an all new sprinkler arrangement and the area 26 includes new sprinklers 22 that have replaced the other type of sprinklers 32. In some examples, all of the conventional existing sprinklers 32 in a building are replaced with new sprinklers 22 to provide a complete update to the system.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of installing misting fire suppression sprinklers into a building previously containing at least one other type of sprinkler, comprising the steps of:
installing at least one misting fire suppression sprinkler where the at least one misting fire suppression sprinkler can introduce a fire suppression mist into a selected portion of the building;
establishing fluid communication between the at least one misting fire suppression sprinkler and a liquid supply conduit previously within the building, the liquid supply conduit having been configured to supply fire suppression liquid to the other type of sprinkler; and
installing a gas supply conduit within the building in fluid communication with the misting fire suppression sprinkler such that the misting fire suppression sprinkler is situated for selectively producing a fire suppression mist using gas from the gas supply conduit and liquid from the liquid supply conduit.

2. The method of claim 1, wherein the other type of sprinkler remains in the building after the misting fire suppression sprinkler is installed and the step of establishing fluid communication comprises installing at least one additional conduit between the misting fire suppression sprinkler and the liquid supply conduit.

3. The method of claim 2, wherein the selected portion of the building did not previously have any fire suppression protection and installing the misting fire suppression sprinkler provides protection for the portion of the building.

4. The method of claim 1, comprising replacing the one type of sprinkler with the misting fire suppression sprinkler.

5. The method of claim 1, wherein the misting fire suppression sprinkler comprises a dual fluid sprinkler.

6. The method of claim 5, wherein the sprinkler comprises an effervescent sprinkler nozzle that produces the fire suppression mist using effervescent atomization.

7. The method of claim 1, wherein the liquid comprises water and the gas comprises air.
